(19) United States
(12) Patent Application Publication
(10) Pub. No.: US 2016/0004630 A1
(43) Pub. Date: Jan. 7, 2016

(54) OPPORTUNISTIC ERROR INJECTION

(71) Applicant: International Business Machines Corporation, Armonk, NY (US)

(72) Inventors: Joel L. Masser, San Jose, CA (US); David C. Reed, Tucson, AZ (US); Max D. Smith, Tucson, AZ (US)

(73) Assignee: International Business Machines Corporation, Armonk, NY (US)

(21) Appl. No.: 14/321,358

(22) Filed: Jul. 1, 2014

(51) Int. Cl. G06F 11/36

(52) U.S. Cl. CPC G06F 11/3696; G06F 11/3672

(57) ABSTRACT

A method for testing a software product is disclosed. In one embodiment, such a method enables a user to specify a type of standard interface between software components, as well as enable a user to specify a type of error to inject into a software product in response to interaction between the software components through the interface. Once these parameters are established, the method monitors, at runtime, execution of the software components for interaction through the interface. In response to detecting such interaction, the method injects the specified error into the software product. The claimed method has the ability to perform such error injection without needing to modify the software components. In certain embodiments, the method enables a user to specify the type of standard interface and/or error to inject at runtime of the software product. A corresponding system and computer program product are also disclosed.

### BACKGROUND

1. Field of the Invention

This invention relates to systems and methods for testing hardware and software products.

2. Background of the Invention

Quality assurance in hardware and software systems is increasingly important as individuals and organizations rely more and more on computer systems to perform a wide variety of business operations. Prior to and often after release, hardware and software systems are tested to assess their quality and robustness in different scenarios. With regard to software, tests may be performed during the software development process to check code syntax, code style, error handling, and the like. Tests may also be performed at runtime to check code performance, error handling, scalability, integration between components, compatibility of components, and the like. Software testing may provide an objective, independent view of software to allow individuals or organizations to appreciate and understand the risks of a particular software implementation.

One common technique for testing software is to use error injection to validate error recovery logic in the software. Such a technique may be used to introduce errors into code paths, such as error-handling code paths, that might otherwise not be traversed, or only rarely traversed, during normal execution. This technique of often used to perform software stress testing and is generally considered to be a important step to develop robust software. Traditionally, this technique involves injecting errors into software at specific sites that are deliberately coded into the software. Existing products or modules may need to be modified, recompiled, and installed in order to add or remove error injection sites.

In view of the foregoing, what are needed are systems and methods to create error injection points using already existing areas of code that provide a different functionality. Such systems and methods would ideally be capable of injecting errors in a wide variety of different software applications without requiring changes to the applications.

### SUMMARY

The invention has been developed in response to the present state of the art and, in particular, in response to the problems and needs in the art that have not yet been fully solved by currently available systems and methods. Accordingly, systems and methods are disclosed to facilitate improved testing of software products. The features and advantages of the invention will become more fully apparent from the following description and appended claims, or may be learned by practice of the invention as set forth hereinafter.

Consistent with the foregoing, a method for testing a software product is disclosed. In one embodiment, such a method enables a user to specify a type of standard interface between software components, as well as enable a user to specify a type of error to inject into a software product in response to interaction between the software components through the interface. Once these parameters are established, the method monitors, at runtime, execution of the software components for interaction through the interface. In response to detecting such interaction, the method injects the specified error into the software product. The claimed method has the ability to perform such error injection without needing to modify the software components. In certain embodiments, the method enables a user to specify the type of standard interface and/or error to inject at runtime of the software product.

A corresponding system and computer program product are also disclosed and claimed herein.

### BRIEF DESCRIPTION OF THE DRAWINGS

In order that the advantages of the invention will be readily understood, a more particular description of the invention briefly described above will be rendered by reference to specific embodiments illustrated in the appended drawings. Understanding that these drawings depict only typical embodiments of the invention and are not therefore to be considered limiting of its scope, the invention will be described and explained with additional specificity and detail through use of the accompanying drawings, in which:

FIG. 1 is a high-level block diagram showing one example of a computing system in which a system and method in accordance with the invention may be implemented;

FIG. 2 is a high-level block diagram showing interfaces for enabling interaction between software components;

FIG. 3 is a high-level block diagram showing diversion to an error injection module when one software component calls another software component;

FIG. 4 is a high-level block diagram showing diversion to an error injection module when one software component returns to another software component;

FIG. 5 is a high-level block diagram showing diversion to an error injection module when one software component calls another software component, with the error injection module returning directly to the calling software component; and

FIG. 6 is a flow diagram showing one embodiment of a method for setting up an error injection module in accordance with the invention; and

FIG. 7 is a flow diagram showing runtime operation of an error injection module in accordance with the invention.

### DETAILED DESCRIPTION

It will be readily understood that the components of the present invention, as generally described and illustrated in the Figures herein, could be arranged and designed in a wide variety of different configurations. Thus, the following more detailed description of the embodiments of the invention, as represented in the Figures, is not intended to limit the scope of the invention, as claimed, but is merely representative of certain examples of presently contemplated embodiments in accordance with the invention. The presently described embodiments will be best understood by reference to the drawings, wherein like parts are designated by like numerals throughout.

The present invention may be embodied as a system, method, and/or computer program product. The computer program product may include a computer readable storage medium (or media) having computer readable program instructions thereon for causing a processor to carry out aspects of the present invention.

The computer readable storage medium may be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on a user's computer, partly on a user's computer, as a stand-alone software package, partly on a user's computer and partly on a remote computer, or entirely on a remote computer or server. In the latter scenario, a remote computer may be connected to a user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, may be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

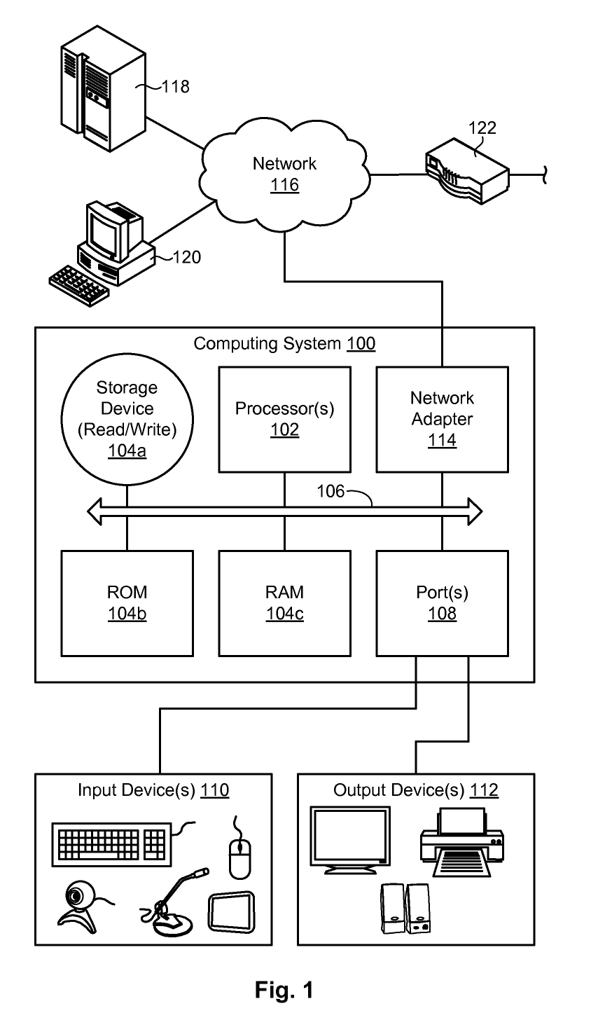

Referring to FIG. 1, one example of a computing system 100 is illustrated. The computing system 100 is presented to show one example of an environment where a system and method in accordance with the invention may be implemented. The computing system 100 is presented only by way of example and is not intended to be limiting. Indeed, the systems and methods disclosed herein may be applicable to a wide variety of different computing systems in addition to the computing system 100 shown. The systems and methods disclosed herein may also potentially be distributed across multiple computing systems 100.

As shown, the computing system 100 includes at least one processor 102 and may include more than one processor 102. The processor 102 may be operably connected to a memory 104. The memory 104 may include one or more non-volatile storage devices such as hard drives 104a, solid state drives 104a, CD-ROM drives 104a, DVD-ROM drives 104a, tape drives 104a, or the like. The memory 104 may also include non-volatile memory such as a read-only memory 104b (e.g., ROM, EPROM, EEPROM, and/or Flash ROM) or volatile memory such as a random access memory 104c (RAM or operational memory). A bus 106, or plurality of buses 106, may interconnect the processor 102, memory devices 104, and other devices to enable data and/or instructions to pass therebetween.

To enable communication with external systems or devices, the computing system 100 may include one or more ports 108. Such ports 108 may be embodied as wired ports 108 (e.g., USB ports, serial ports, Firewire ports, SCSI ports, parallel ports, etc.) or wireless ports 108 (e.g., Bluetooth, IrDA, etc.). The ports 108 may enable communication with one or more input devices 110 (e.g., keyboards, mice, touchscreens, cameras, microphones, scanners, storage devices, etc.) and output devices 112 (e.g., displays, monitors, speakers, printers, storage devices, etc.). The ports 108 may also enable communication with other computing systems 100.

In certain embodiments, the computing system 100 includes a network adapter 114 to connect the computing system 100 to a network 116, such as a LAN, WAN, or the Internet. Such a network 116 may enable the computing system 100 to connect to one or more servers 118, workstations 120, personal computers 120, mobile computing devices, or other devices. The network 116 may also enable the computing system 100 to connect to another network by way of a router 122 or other device 122. Such a router 122 may allow the computing system 100 to communicate with servers, workstations, personal computers, or other devices located on different networks.

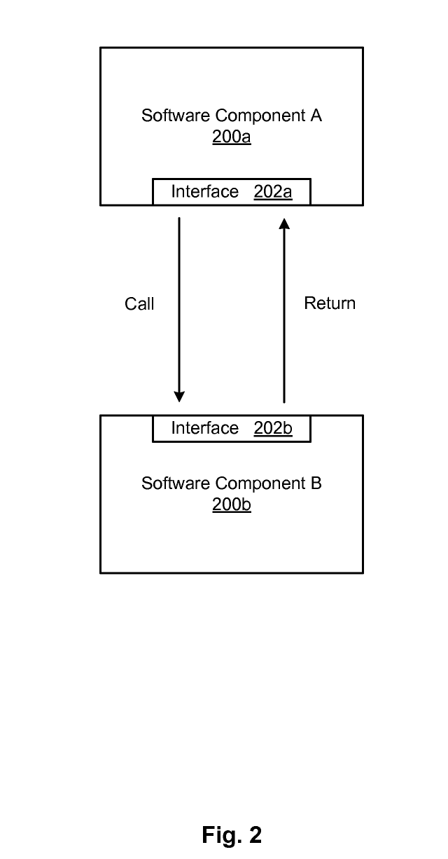

Referring to FIG. 2, as previously mentioned, assuring the quality of hardware or software systems is important as individuals and organizations increasingly rely on computer systems to perform a wide variety of business operations. Prior to and often after release, hardware and software systems may be tested to assess their quality and robustness in different scenarios. One common technique used to test software systems is to inject errors into the software to validate error recovery logic. Using such a technique, errors may be introduced into code paths, such as error-handling code paths, that might otherwise not be traversed, or only rarely traversed, during normal execution. Error injection may be used to alter storage, modify return codes or values, or simulate other error events by injecting errors at specific points in program code.

Traditionally, error injection techniques involve injecting errors into software at specific sites that are deliberately coded into the software. To accomplish this, existing products or modules typically need to be modified, recompiled, and installed in order to add or remove error injection sites. This can require significant time and effort. It would be an advance in the art to provide improved systems and methods to create error injection points using already existing areas of code that are currently providing a different functionality. Such systems and methods would ideally be capable of injecting errors in a wide variety of different software applications without requiring any actual changes to the applications.

Rather than utilizing error injection sites which are deliberately coded into software, systems and methods in accordance with the invention may utilize standard interfaces 202 that already exist between software components 200, as shown in FIG. 2. Such standard interfaces may include existing program features or APIs such as trace points, SVC calls, exit points, entry points, system trace entries, or other mechanisms where one software component 200a makes a standardized call or communication to another 200b. Systems and methods in accordance with the invention may intercept communications or calls through these standard interfaces 202 to enable various changes to be made to the program state before returning to a caller 200a or before continuing processing. Such a technique allows different types of errors to be injected into an existing computer program without requiring modification of the program.

Systems and methods in accordance with the invention may also enable various types of events to have error injection taking place simultaneously. That is, because certain types of calls may be occurring frequently and in some cases substantially simultaneously, systems and methods in accordance with the invention may likewise inject errors frequently or substantially simultaneously. The systems and methods have the ability to inject different types of errors for different types of calls, inject the same type of errors for different types of calls, or inject different types of errors for the same type of call. For example, with regard to the last item, a first call of a software component may prompt a first error to be injected into the program code, whereas a second call of the same software component (or another instance of the same software component) may prompt a second error to be injected into the program code.

In certain embodiments, systems and methods in accordance with the invention may be configured to inject errors with different frequencies and/or with different levels of predictability. For example, an error may be injected for every Nth occurrence of a function call, where N is a constant, changing, or random number. The function call for which the error is injected could be the same function call or the function call could vary. Similarly, the type of error that is injected could be the same or the type of error could vary. For example, the type of error injected could be random and/or an error could be injected into random types of function calls and/or at random frequencies or times during execution of the program code. Other possibilities exist and are within the scope of the invention.

Systems and methods in accordance with the invention may enable a user to set parameters such as when errors are injected, what types of errors are injected, how frequently errors are injected, and under what circumstance errors are injected into the program code. The disclosed systems and methods are unique from tools or products that capture a vector table entry in that such tools or products are dependent on a particular access point in the program code whereas the disclosed systems and methods can insert error injection logic at any access point at the discretion of a user. This greatly expands the range of points where errors can be injected and the types of errors that can be injected, enables the possibility of cross-component error injection (as opposed to error injection exclusively within software components), and eliminates the need to modify the source code of a product in order to provide error injection capability.

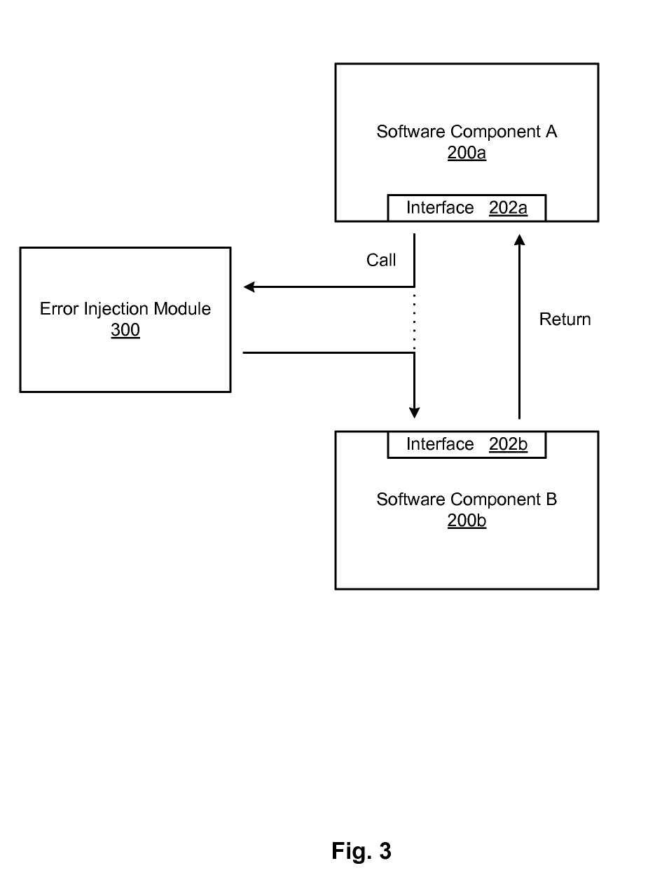

Error injection logic may be invoked at different times or places in the program code, at the discretion of a user. FIG. 3 shows one example of an error injection module 300 that is invoked when a first software component 200a calls a second software component 200b. Once the error injection module 300 has finished executing, the second software component 200b may be called and executed as originally intended. In other embodiments, the second software component 200b could be called after the error injection module 300 has been invoked but before the error injection module 300 has finished executing, leading to concurrent or substantially concurrent execution between the error injection module 300 and the second software component 200b. Once the second software component 200b has finished executing, it may return control to the first software component 200a.

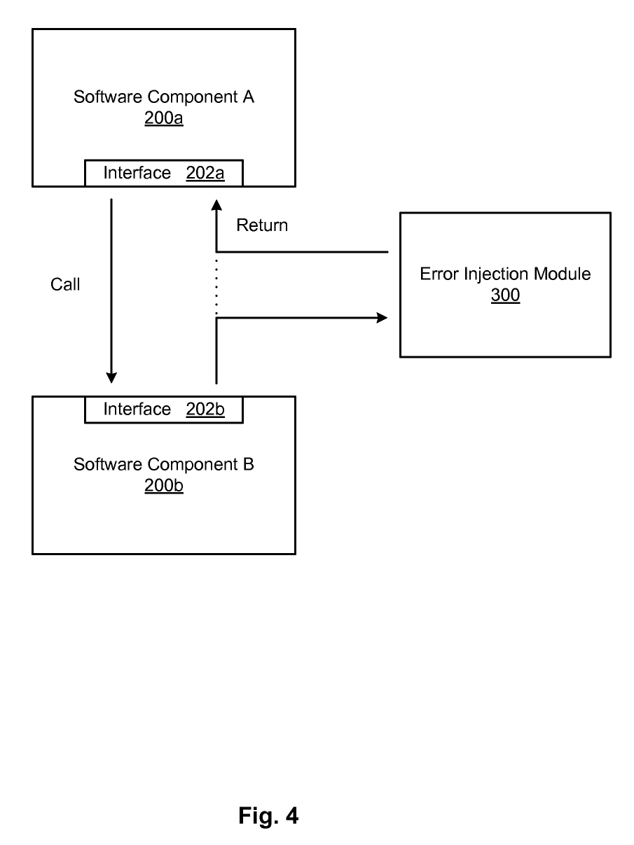

In other embodiments, an error injection module 300 in accordance with the invention may be invoked when the second software component 200b returns execution to the first software component 200a, as shown in FIG. 4. As shown, once the error injection module 300 has finished executing, control may be returned to the first software component 200a. In other embodiments, after calling the error injection module 300 but before the error injection module 300 has finished executing, control may be returned to the first software component 200a, leading to concurrent or substantially concurrent execution between the error injection module 300 and the first software component 200a.

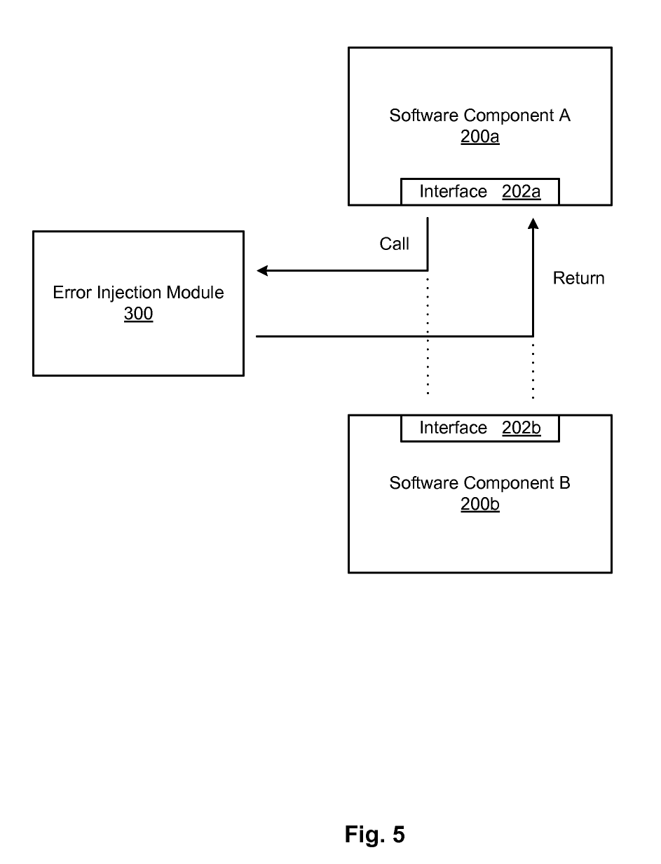

In other embodiments, an error injection module 300 in accordance with the invention may be executed in place of or instead of the second software component 200b, as shown in FIG. 5. For example, when the first software component 200a calls the second software component 200b, the call may be intercepted and the error injection module 300 may be invoked. Once the error injection module 300 has finished executing, control may be returned directly to the first software component 200a, thereby bypassing the second software component 200b. In certain embodiments, the error injection module 300 may substantially mimic functionality of the second software component 200b. For example, instead of allowing the second software component 200b to return a value to the first software component 200a, the error injection module 300 may inject an error by returning an erroneous value to the first software component 200a.

Embodiment of the inventions may use different types of standard interfaces to inject errors. For example, the error injection module 300 may be invoked in response to a hardware instruction such as Monitor Call, which is used to invoke a program such as a generalize trace facility (GTF) tracing module. In other embodiments, the error injection module 300 may be invoked upon entry to or exit from a component trace module that is a common entry or exit point for most or all trace calls. In such an embodiment, an error may be injected when a program writes a trace entry to a trace file or log. The error injection module 300 may also be invoked at a common exit point from a number of services, such as SVC calls (system service calls that are standard routines used to do things such as obtain storage or obtain a lock on existing storage). Errors may also be injected in response to asynchronous tracing routines that perform tracing at specific time intervals. Unlike tracing routines that are called at specific locations in program code, asynchronous tracing routines may be called at specific times or intervals independent of program execution. Errors may be injected at these times or intervals regardless of the state of program execution. In other embodiments, an error injection module 300 may be invoked at user exit points (points where user-inserted code terminates execution through a common exit point). In yet other embodiments, the error injection module 300 may be invoked when hardware-assisted routines (i.e., routines performed by hardware that may traditionally be performed by software) are called or exited. These represent just a few non-limiting examples of standard interfaces that could be used to invoke an error injection module 300 in accordance with the invention.

Various different techniques may be used to intercept calls or interactions through a standard interface, including setting or modifying a vector table entry, establishing a user exit, or installing patch code. In certain embodiments, embodiments of the invention may take advantage of the fact that many module addresses are stored in various tables in a system. When a first software component 200a (e.g., process) needs to call a second software component 200b (e.g., a service), the first software component 200a may look up the address of the second software component 200b in the appropriate table of addresses. In certain embodiments of the invention, one or more of these addresses may be modified so that control passes to the error injection module 300 before or instead of passing to the second software component 200b. In this way, an error injection module 300 injecting a desired error may be placed or located at any point specified in a vector table. Similarly, embodiments of the invention may enable a user to specify where an error injection module 300 is located and modify the vector table accordingly.

Various types of errors may be injected by a error injection module 300 in accordance with the invention. For example, the error injection module 300 may modify storage or a register to precipitate an error. In other embodiments, the error injection module 300 may set a return code (a value returned from one software component 200 to another) to a value that will precipitate an error. In other embodiments, the error injection module 300 may modify or corrupt data, including channel programs (I/O that is sent to hardware devices, such as storage devices, to instruct them what to do). In yet other embodiments, the error injection module 300 may cause a program check (an exception condition that needs to be handled by a program). In yet other embodiments, the error injection module 300 may insert a delay into program code that may in turn cause or precipitate an error.

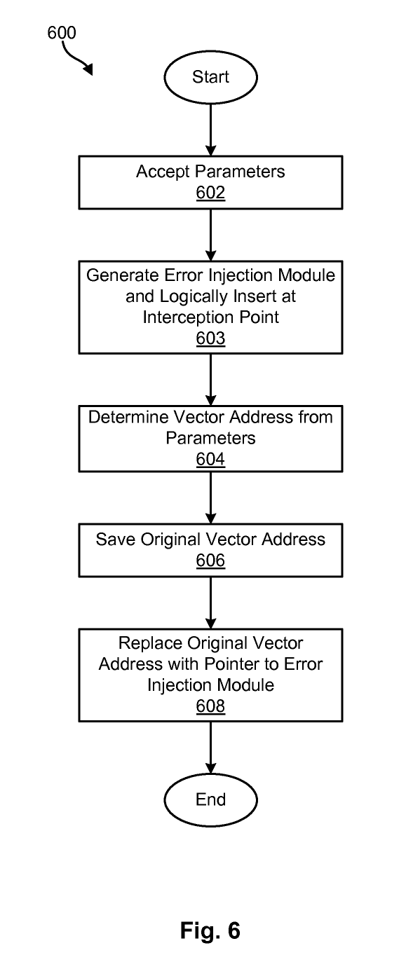

Referring to FIG. 6, one embodiment of a method 600 for setting up an error injection module 300 in accordance with the invention is illustrated. As shown, the method 600 initially accepts 602 parameters designating how errors are injected. Such parameters may designate, for example, when errors are injected, what types of errors are injected, how frequently errors are injected, and under what circumstances (e.g., function calls, interactions through standard interfaces, etc.) errors are injected into a program. Other parameters may include filtering criteria, such as a delay interval, what users or jobs may be subject to an error, or the like. Using the parameters, a error injection module 300 may be generated 603 and logically inserted 603 at an interception point. A vector address for the error injection module 300 may then be determined 604 and the original vector address may be saved 606. The original vector address may then be replaced 608 with the vector address of the error injection module 300.

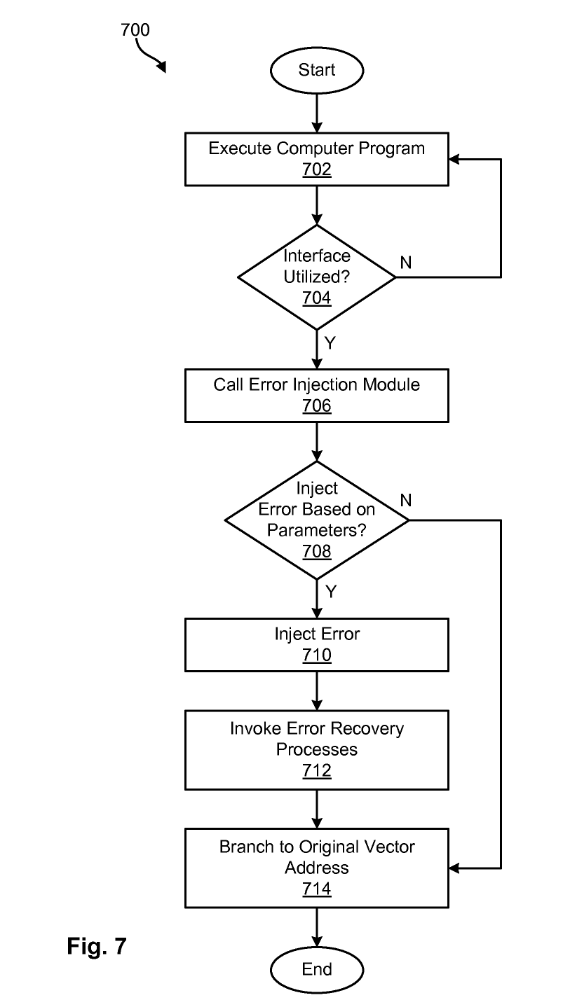

Referring to FIG. 7, a flow diagram showing runtime operation of an error injection module 300 in accordance with the invention is illustrated. As shown, at runtime, a computer program subject to error injection is executed 702. If, at step 704, a designated interface has been utilized in a designated manner (e.g., a call is made through the interface, execution is returned through the interface, etc.), the error injection module 300 established by the method 600 of FIG. 6 is called 706. The error injection module 300 may then determine 708 whether to inject an error based on the parameters that were established for the error injection module 300. For example, if the error injection module 300 is configured to inject an error for every Nth call through the interface, the error injection module 300 may inject 710 the error if the call is the Nth call while foregoing error injection if the call is not the Nth call. Other parameters may also be used to determine whether an error is or is not injected. If an error is injected 710, error recovery processes of the computer program will ideally be invoked 712, thereby allowing error recovery logic to be observed and tested. The method 700 may then branch 714 to the original vector address, or alternatively, return directly back to the calling software component without branching to the original vector address.

Unlike conventional error injection functionality which is typically hard-coded into a software product that is under test, the disclosed systems and methods provide a significantly greater amount of flexibility. For example, a user may modify the parameters described above to change when errors are injected, what types of errors are injected, how frequently errors are injected, and under what circumstances errors are injected into a program. In certain embodiments, functionality may be provided to enable the user to change parameters at runtime, thereby allowing operation of the error injection module 300 to be modified on the fly.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

1. A method for testing a software product, the method comprising:
enabling a user to specify a type of standard system service provided by an operating system;
enabling a user to specify a type of error to inject in response to detecting a call to the system service by a software component; and
performing the following without modifying the software component or system service to support error injection:
monitoring, at runtime, the call to the system service by the software component; and
injecting, at runtime, the error in response to detecting the call.

2. The method of claim 1, further comprising enabling a user to specify that the error be injected for every Nth occurrence of the call, wherein N is a whole number greater than one.

3. The method of claim 1, wherein the system service call is a hardware instruction used to invoke a program.

4. The method of claim 1, wherein the system service is configured to one of obtain storage and obtain a lock on existing storage.

5. The method of claim 1, wherein the system service is configured to execute a tracing routine.

6. The method of claim 1, wherein the type of error changes for each occurrence of the call.

7. The method of claim 1, further comprising injecting an error at the time the system service returns execution to the software component.

8. A computer program product for testing a software product, the computer program product comprising a computer-readable storage medium having computer-usable program code embodied therein, the computer-usable program code comprising:
computer-usable program code to enable a user to specify a type of standard system service provided by an operating system;
computer-usable program code to enable a user to specify a type of error to inject in response to detecting a call to the system service by a software component; and
computer-usable program code to perform the following without modifying the software component or system service to support error injection:
monitor, at runtime, the call to the system service by the software component; and
inject, at runtime, the error in response to detecting the call.

9. The computer program product of claim 8, further comprising computer-usable program code to enable a user to specify that the error be injected for every Nth occurrence of the call, wherein N is a whole number greater than one.

10. The computer program product of claim 8, wherein the system service call is a hardware instruction used to invoke a program.

11. The computer program product of claim 8, wherein the system service is configured to one of obtain storage and obtain a lock on existing storage.

12. The computer program product of claim 8, wherein the system service is configured to execute a tracing routine.

13. The computer program product of claim 8, wherein the type of error changes for each occurrence of the call.

14. The computer program product of claim 8, further comprising computer-usable program code to inject an error at the time the system service returns execution to the software component.

15. A system for testing a software product, the system comprising:
at least one processor;
at least one memory device coupled to the at least one processor and storing instructions for execution on the at least one processor, the instructions causing the at least one processor to:
enable a user to specify a type of standard system service provided by an operating system;
enable a user to specify a type of error to inject in response to detecting a call to the system service by a software component; and
perform the following without modifying the software component or system service to support error injection:
monitor, at runtime, the call to the system service by the software component; and
inject, at runtime, the error in response to detecting the call.

16. The system of claim 15, wherein the instructions further enable a user to specify that the error be injected for every Nth occurrence of the call, wherein N is a whole number greater than one.

17. The system of claim 15, wherein the type of error changes for each occurrence of the call.

18. The system of claim 15, wherein the system service is configured to one of obtain storage and obtain a lock on existing storage.

19. The system of claim 15, wherein the system service is configured to execute a tracing routine.

20. The system of claim 15, wherein the instructions are further configured to inject an error at the time the system service returns execution to the software component.
